(19) United States
(12) Patent Application Publication
(10) Pub. No.: US 2002/0136468 A1
(43) Pub. Date: Sep. 26, 2002

(54) Method for interactive image retrieval based on user-specified regions

(76) Inventor: Hung-Ming Sun, Tou-Liu City (TW)

Correspondence Address: BIRCH STEWART KOLASCH & BIRCH, PO BOX 747, FALLS CHURCH, VA, 22040-0747, US

(21) Appl. No.: 09/974,792

(22) Filed: Oct. 12, 2001

(30) Foreign Application Priority Data
Mar. 20, 2001 (TW) 90106431

(51) Int. Cl. G06K 9/48

(52) U.S. Cl. 382/305; 382/199; 382/173

(57) ABSTRACT

A method of interactive image retrieval based on user-specified regions. First, a sample image is provided. Next, the system automatically divides the sample image into a plurality of regions and extracts their features. Then, the user selects one or more sample regions and defines corresponding logic operators between them; a composite query is constructed and input for image retrieval. Finally, the system searches the image database to find the images containing regions corresponding with the composite query. Compared with the conventional image retrieval methods, the present invention allows users to select sample regions and exclude undesirable regions intuitively so that more accurate image retrieval can be attained in a more straightforward way.

### BACKGROUND OF THE INVENTION

1. Field of the Invention

The present invention relates to an image retrieval method, more particularly to an interactive image retrieval method utilizing logic operation based on user-specified objects for interactive image retrieval. By associating suitable local objects with corresponding logic operators, a more straightforward manipulation can be designed to attain more accurate image retrieval results.

2. Description of the Prior Art

In most of the conventional image retrieval methods, feature extraction is the first step for treating the sample image. The image features concerned are color distribution, texture, shape, etc. Then, based upon the extracted features, the image database is searched to find the images matching well. However, in such systems, users have no way to specify what is their target regions or objects for retrieval so the results could not generally meet the users' expectation well.

For example, if one user provides an image that contains sky, mountains, rivers and a bridge, what he/she looks for is a photograph of scenery. However, if another user also provides the same image but only looks for a photograph with a bridge, the difference between the two users cannot be differentiated by conventional image retrieval methods. This is because with conventional image retrieval methods, the users were not allowed the option of determining for themselves the retrieval target in the photograph.

### SUMMARY OF THE INVENTION

Therefore, the main object of the present invention is to provide an image retrieval method that allows users to self-determine the retrieval target. Users can choose one or more retrieval targets and use logic operators such as “and”, “or”, “exclusive-or” and “not” and their combinations to retrieve the images that users expect.

In order to achieve the above object, the present invention provides a method for interactive image retrieval based on user-specified objects. First, a sample image is provided. Next, the system automatically divides the sample image into several regions, and extracts their features. Then, the user chooses one or more regions and defines the corresponding logic operators between them; the composite query is input for image retrieval. Finally, the system searches the image database to find the images containing regions corresponding with the composite query.

Alternatively, the feature extraction can be carried out after the user chooses the sample regions; thus, only the chosen regions need to compute features and the processing time can be saved.

The present invention can be implemented in another way. First, a sample image is provided. Next, the user uses a region selection tool, which is provided by the system, to segment out one or more sample regions and define the corresponding logic operators between them. Then, the system automatically extracts features from the individual regions and create a composite query. Finally, the system searches the image database to find the images containing regions corresponding with the composite query.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows the flow diagram of the interactive image retrieval method based on user-specified regions according to the first embodiment of the present invention.

FIG. 2 shows the flow diagram of the interactive image retrieval method based on user-specified regions according to the second embodiment of the present invention.

### DETAILED DESCRIPTION OF THE PREFERRED EMBODIMENT

First embodiment:

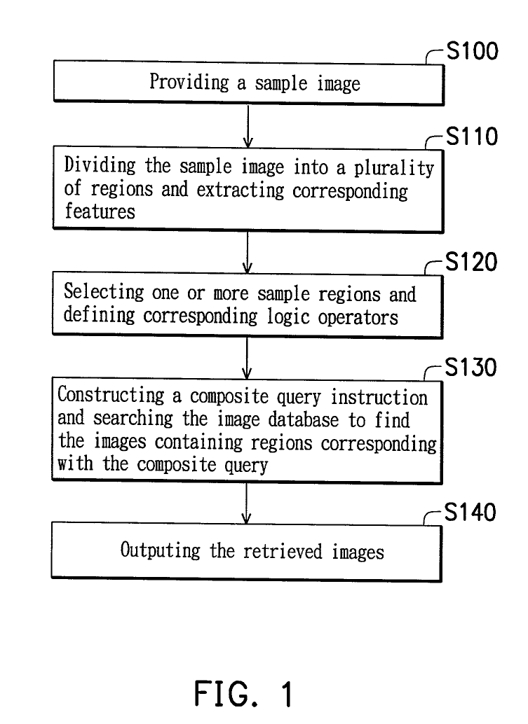

FIG. 1 is a flow diagram of the interactive image retrieval method based on user-specified regions according to the first embodiment of the present invention.

First, as step S100, the user provides a sample image, for example, the one that contains a butterfly and a flower in the appending diagram 1 (attachment 1). Then, as step 110, the sample image is divided into a plurality of regions, and the features of these regions are extracted.

Dividing the sample image into a plurality of regions can be achieved by edge detection, color quantization, region splitting and merging or region growing methods. The image features can be color distribution, texture, position, shape of the regions, tone, brightness and chromatic saturation. The result of the sample image after region segmentation is shown in the appending diagram 2 (attachment 2).

At step 120, the user selects the sample regions from the segmented sample image. One or more sample regions can be selected. The logic operators such as “and”, “or”, “exclusive-or” and “not” between these sample regions are also defined. For example, the user selects the regions A and B in the appending diagram 2 (attachment 2) and defines the logic operators to be “(A) and (not B)”. This indicates that the image to be retrieved is the butterfly but not the flower.

At step S130, according to the sample regions and the specified logic operators, a composite query instruction is constructed, such as “(region A) and (not region B), ((region 1) and (region 2)) and (not region 3)” or “((region 1) or (region 2)) and (not region 3)”. The image database is then searched to find the images containing regions corresponding with the composite query.

Finally, as step S140, the images that satisfy the query instruction are output.

An alternative work flow is possible to increase the computation efficiency. The feature extraction process at step S110 can be performed after the user selects sample regions so that only the chosen sample regions need to carry out feature extraction.

Second embodiment:

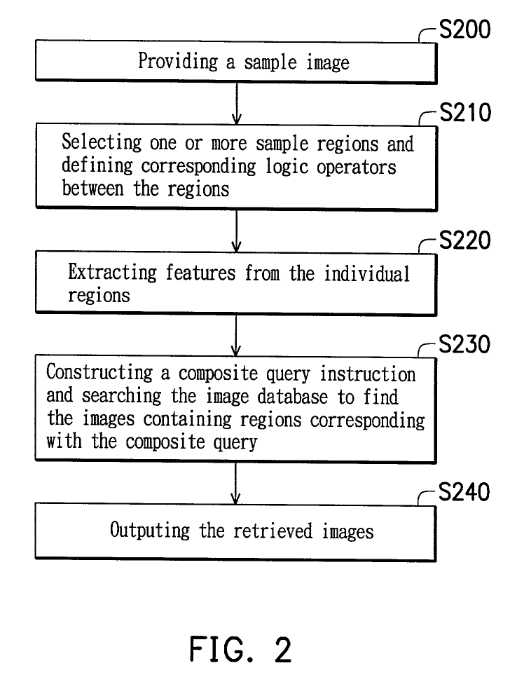

FIG. 2 is the flow diagram of the interactive image retrieval method based on user-specified regions according to the second embodiment of the present invention. Referring to FIG. 2, the detail is described below.

First, as step S200, the user provides a sample image, for example, the sample image shown in the appending diagram 3 (attachment 3) that contains a lotus flower and lotus leaf.

Then, at step S210, the user selects one or more sample regions using a region selection tool, which is provided by the system , and defines the logic operators associated with these sample regions. The logic operators can be “and”, “or”, “exclusive-or” and “not”. For example, the user selects regions C and D and defines the associated logic operators to be “and”, as shown in the appending diagram 4 (attachment 4); this indicates that the image to be retrieved is a green leaf in association with a red flower.

Next, at step S220, the system automatically extracts features from these sample regions. The features can be color distribution, texture, position, shape of the regions, tone, brightness and chromatic saturation.

At step S230, a composite query instruction is constructed according to the sample regions and the designated logic operators, such as “(region C) and (region D), ((region 1) and (region 2)) and (not region 3)” or “((region 1) or (region 2)) and (not region 3)”. The image database is then searched to find the images containing regions corresponding with the composite query.

Finally, as step S240, the images that satisfy the query instruction are output.

Thus, image retrieval can be achieved based on the user-specified regions and their logic relations. The present invention allows users to select sample regions and exclude undesirable regions intuitively, so that more accurate image retrieval can be attained in a more straightforward way. Moreover, different users may choose different sample regions for the same images to produce their expected results. This overcomes the drawbacks of the conventional image retrieval systems and methods.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of interactive image retrieval based on user-specified regions, comprising:
providing a sample image;
dividing the sample image into a plurality of regions;
selecting one or more sample regions for feature extraction, and defining corresponding logic operators; and
constructing a composite query instruction based on the selected sample regions and their corresponding logic operators and searching the image database according to the composite query instruction.

2. The method as claimed in claim 1, comprising selecting the images that contain the regions corresponding with the composite query instruction.

3. The method as claimed in claim 1, wherein the step of dividing the sample image into a plurality of regions uses a edge detection method to divide the sample image into a plurality of regions.

4. The method as claimed in claim 1, wherein the step of dividing the sample image into a plurality of regions uses a color quantization method to divide the sample image into a plurality of regions.

5. The method as claimed in claim 1, wherein the step of dividing the sample image into a plurality of regions uses a region splitting and merging method to divide the sample image into a plurality of regions.

6. The method as claimed in claim 1, wherein the step of dividing the sample image into a plurality of regions uses a region growing method to divide the sample image into a plurality of regions.

7. The method as claimed in claim 1, wherein the image features include color distribution, texture, position and shape.

8. The method as claimed in claim 1, wherein the image features include tone, brightness and chromatic saturation.

9. The method as claimed in claim 1, wherein the logic operators include “and”, “or”, “exclusive-or” and “not”.

10. A method of interactive image retrieval based on user-specified regions, comprising:
providing a sample image;
selecting one or more sample regions from the sample image by a region selection tool and defining corresponding logic operators between the selected regions;
extracting the image features of the selected sample regions; and
constructing a composite query instruction based on the selected sample regions and their corresponding logic operators and searching the image database according to the composite query instruction.

11. The method as claimed in claim 10, comprising selecting the images that contain the regions corresponding with the composite query instruction.

12. The method as claimed in claim 10, wherein the image features include color distribution, texture, position and shape.

13. The method as claimed in claim 10, wherein the image features include tone, brightness and chromatic saturation.

14. The method as claimed in claim 10, wherein the logic operators include “and”, “or”, “exclusive-or” and “not”.
